(19) United States
(12) Patent Application Publication
(10) Pub. No.: US 2015/0325960 A1
(43) Pub. Date: Nov. 12, 2015

(54) UNIVERSAL SERIAL BUS INTERFACE AND MOBILE DEVICE

(71) Applicant: Acer Incorporated, New Taipei City (TW)

(72) Inventors: Chih-Yung TSAI, New Taipei City (TW); Chih-Cheng CHEN, New Taipei City (TW)

(21) Appl. No.: 14/695,896

(22) Filed: Apr. 24, 2015

(30) Foreign Application Priority Data
May 9, 2014 (TW) 103116483

(51) Int. Cl. H01R 13/66; H01R 27/00; H01R 13/35

(52) U.S. Cl. CPC H01R 13/6683; H01R 13/35; H01R 27/00

(57) ABSTRACT

A universal serial bus (USB) interface is provided. The universal serial bus (USB) interface includes a customized USB socket, a detection member and a control unit. The customized USB socket has an accommodating portion for connecting a standard USB plug or an output plug of a power converter, wherein the depth of the accommodating portion is greater than the depth of a standard USB socket. The detection member is disposed in the accommodating portion. The control unit changes the status of an output signal to inform the power converter of outputting electric power that is greater than that defined by a standard USB specification when the output plug of the power converter is in contact with the detection member.

### CROSS REFERENCE TO RELATED APPLICATION

The present application is based on, and claims priority from, Taiwan (International) Application Serial Number 103116483, filed May 9, 2014, the invention of which is hereby incorporated by reference herein in its entirety.

### TECHNICAL FIELD

The disclosure relates to a universal serial bus (USB) interface, and more particularly to a universal serial bus interface for adjusting a charging mechanism according to a standard USB plug or an output plug of a power converter (i.e. an adapter).

### BACKGROUND

Nowadays mobile devices are applied with large-capacity batteries. This kind of design can extend battery life and give users a good user experience. Traditionally, each USB specification formulates a maximum current (i.e. USB 3.0 can provide a maximum current up to #900 mA and USB 2.0 can provide a maximum current up to #500 mA) and therefore it merely provides charging of lower wattage (i.e. 4-5W for USB 3.0). The above factors usually result in a long charging time. Thus mobile devices generally use a power converter to provide larger power electricity for charging. Therefore there is a need for providing a charging mechanism which unifies USB and the power converter so that the charging mechanism can provide greater power electricity for charging and perform general data transmission.

### SUMMARY

An embodiment of the present invention provides a universal serial bus (USB) interface. The USB interface includes a customized USB socket, a detection member and a control unit. The customized USB socket has an accommodating portion for connecting a standard USB plug or an output plug of a power converter, wherein the depth of the accommodating portion is greater than the depth of a standard USB socket. The detection member is disposed in the accommodating portion of the customized USB socket, wherein the standard USB plug does not contact the detection member when the standard USB plug is plugged into the customized USB socket, and the output plug of the power converter is in contact with the detection member when the output plug of the power converter is plugged into the customized USB socket. The control unit is coupled to the customized USB socket. The control unit changes the status of an output signal of the control unit when the output plug of the power converter is in contact with the detection member to inform the power converter to output electric power that is greater than that defined by a standard USB specification.

An embodiment of the present invention provides a mobile device. The mobile device includes a main device and a universal serial bus (USB) interface. The USB interface is coupled to the main device. The USB interface includes a customized USB socket, a detection member and a control unit. The customized USB socket has an accommodating portion for connecting a standard USB plug or an output plug of a power converter, wherein the depth of the accommodating portion is greater than the depth of a standard USB socket. The detection member is disposed in the accommodating portion of the customized USB socket, wherein the standard USB plug does not contact the detection member when the standard USB plug is plugged into the customized USB socket, and the output plug of the power converter is in contact with the detection member when the output plug of the power converter is plugged into the customized USB socket. The control unit is coupled to the customized USB socket. The control unit changes the status of an output signal of the control unit when the output plug of the power converter is in contact with the detection member to inform the power converter to output electric power that is greater than that defined by a standard USB specification.

### BRIEF DESCRIPTION OF THE DRAWINGS

The present invention can be more fully understood by reading the subsequent detailed description and examples with references made to the accompanying drawings, wherein:

FIG. 1 shows a block diagram of a mobile device 10 according to an embodiment of the present invention.

FIG. 2 shows an embodiment of the USB interface 12 of FIG. 1.

FIG. 3A and FIG. 3B show the customized USB socket 121 according to an exemplary embodiment of the present invention.

FIG. 4 shows the control unit 123 according to an exemplary embodiment of the present invention.

### DETAILED DESCRIPTION

The following description is of the best-contemplated mode of carrying out the present invention. This description is made for the purpose of illustrating the general principles of the present invention and should not be taken in a limiting sense. The scope of the present invention is best determined by reference to the appended claims

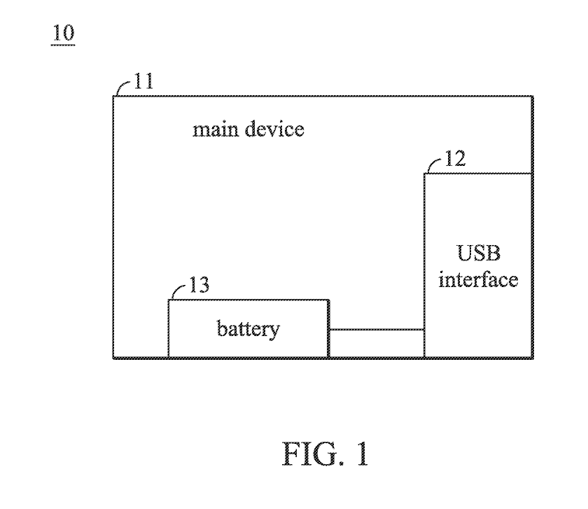

FIG. 1 shows a block diagram of a mobile device 10 according to an embodiment of the present invention. The mobile device 10 includes a main device 11, a universal serial bus (USB) interface 12 and a battery 13. The main device 11 is coupled to the USB interface 12. The USB interface 12 is used to be connected to a USB standard plug to perform general data transmission function. The USB interface 12 also can be used to charge the mobile device 10 through connecting the USB standard plug or an output plug of a power converter (i.e. an adapter). The battery 13 disposed in the mobile device 10 provides electric power for the mobile device 10.

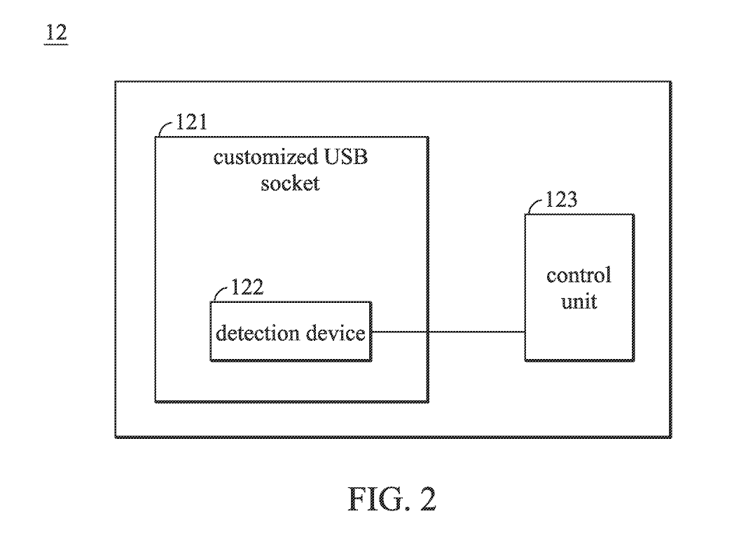

FIG. 2 shows an embodiment of the USB interface 12 of FIG. 1. The USB interface 12 includes a customized USB socket 121, a detection device 122 and a control unit 123. The customized USB socket 121 is used for connection to the USB standard plug to perform general data transmission. The customized USB socket 121 is also used for charging the battery 13 of the mobile device 10 through plugging the USB standard plug or an output plug of a power converter (i.e. an adapter) into the customized USB socket 121. The detection device 122 is disposed in the customized USB socket 121. The detection device 122 is used to detect which plug (the USB standard plug or the output plug of the power converter) is inserted into the customized USB socket 121. The control unit 123 is coupled to the customized USB socket 121. When the detection device 122 detects that the output plug of the power converter is inserted into the customized USB socket 121, the control unit 123 informs the power converter to output electric power that is greater than that defined by a standard USB specification.

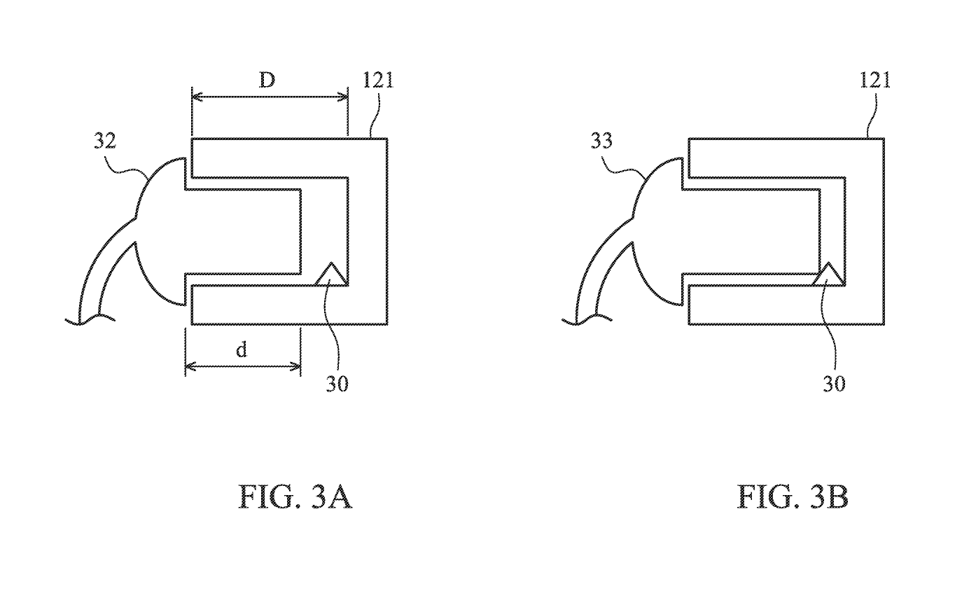

FIG. 3A and FIG. 3B show the customized USB socket 121 according to an exemplary embodiment of the present invention. In this embodiment, the customized USB socket 121 has an accommodating portion for connecting to a standard USB plug 32 or an output plug of a power converter 33. The detection device 122 includes a detection member 30 which is disposed in the accommodating portion of the customized USB socket 121. Here, the detection member 30 is a metal sheet, for example, but is not limited thereto. Refer to FIG. 3A, the depth D of the accommodating portion is greater than the depth of a standard USB socket (i.e., the depth D of the accommodating portion is greater than the length d of the standard USB plug 32). Therefore the standard USB plug 32 does not contact the detection member 30 when the standard USB plug 32 is inserted into the customized USB socket 121. In this embodiment, the detection member 30 is connected to a ground node (not shown in FIG. 3B) when the detection member 30 is in contact with the output plug of the power converter 33 (shown in FIG. 3B).

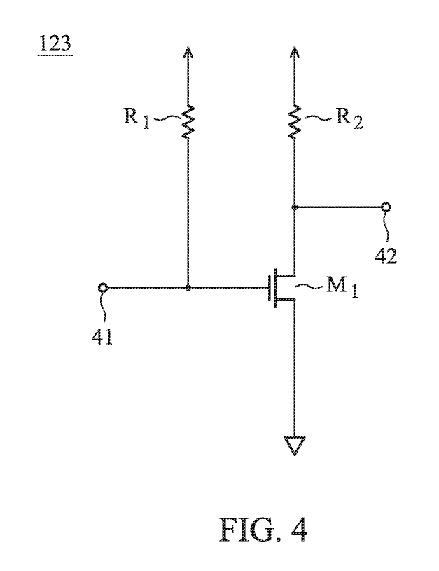

FIG. 4 shows the control unit 123 according to an exemplary embodiment of the present invention. In this embodiment, the control unit 123 is a control circuit. The control circuit 123 comprises a resistor R1, a resistor R2 and a transistor M1, wherein the input and output of the control circuit 123 respectively correspond to an input node 41 connecting the gate of the transistor M1, and an output node 42 connecting the drain of the transistor M1. Voltage sources V1 and V2 are at high voltage potential. The input node 41 is further connected to the detection member 30. The output node 42 is further connected to a detection pin. If the customized USB socket 121 meets the USB 3.0 specification, then the detection pin is the seventh pin of the customized USB socket 121. If the customized USB socket 121 meets the Mini/Micro USB 2.0 specification, then the detection pin is the fourth pin of the customized USB socket 121.

As shown in FIG. 3A, the standard USB plug 32 does not contact the detection member 30 when the standard USB plug 32 is inserted into the customized USB socket 121. At this time, the voltage potential of the detection member 30 is high and the transistor M1 turns on so that the voltage potential of an output signal of the control unit 123 (at the output node 42) remains low. In other words, the seventh pin of the customized USB socket 121 with the USB 3.0 specification (or the fourth pin of the customized USB socket 121 with the Mini/Micro USB 2.0 specification) remains at the status of ground voltage potential so that the operation of the standard USB plug 32 would not be affected.

As shown in FIG. 3B, the output plug of the power converter 33 is in contact with the detection member 30 and oppresses the detection member 30 to connect the ground node (not shown in FIG. 3B) when the output plug of the power converter 33 is inserted into the customized USB socket 121. At this time, the voltage potential of the detection member 30 and the input node 41 is low, and the transistor Ml turns off so that the voltage potential of the output signal of the control unit 123 (at the output node 42) goes high. The output voltage at the output node 42 is transmitted to the power converter through the seventh pin of the customized USB socket 121 of USB 3.0 specification (or the fourth pin of the customized USB socket 121 with the Mini/Micro USB 2.0 specification), and informs the power converter to output the electric power which is greater than that defined by a standard USB specification.

In one embodiment, the customized USB socket 121 meets the USB 3.0 specification. The output plug of the power converter 33 outputs the power electricity to the mobile device 10 through a first pin and a fourth pin of the customized USB socket 121. The output plug of the power converter 33 has at least three pins corresponding to the first, fourth and seventh pins of the customized USB socket 121.

In another embodiment, the customized USB socket 121 meets the Mini/Micro USB 2.0 specification. The output plug of the power converter 33 outputs the power electricity to the mobile device 10 through a first pin and a fifth pin of the customized USB socket 121. The output plug of the power converter 33 has at least three pins corresponding to the first, fourth and fifth pins of the customized USB socket 121.

While the present invention has been described by way of example and in terms of preferred embodiment, it should be understood that the present invention is not limited thereto. On the contrary, it is intended to cover various modifications and similar arrangements (as would be apparent to a person skilled in the art). Therefore, the scope of the appended claims should be accorded the broadest interpretation so as to encompass all such modifications and similar arrangements.

What is claimed is:

1. A universal serial bus (USB) interface, comprising:
a customized USB socket having an accommodating portion for connecting to a standard USB plug or an output plug of a power converter, wherein the depth of the accommodating portion is greater than the depth of a standard USB socket;
a detection member disposed in the accommodating portion of the customized USB socket, wherein the standard USB plug does not contact the detection member when the standard USB plug is plugged into the customized USB socket, and the output plug of the power converter is in contact with the detection member when the output plug of the power converter is plugged into the customized USB socket; and
a control unit, coupled to the customized USB socket, changing the status of an output signal of the control unit when the output plug of the power converter is in contact with the detection member to inform the power converter to output electric power that is greater than that defined by a standard USB specification.

2. The USB interface of claim 1, wherein an input of the control unit is coupled to the detection member and the detection member is connected to a ground node when the output plug of the power converter is in contact with the detection member, and whereby the voltage potential of the ground node is transmitted, through the detection member, to the control unit and causes the control unit to change the status of the output signal of the control unit.

3. The USB interface of claim 2, wherein the custom USB socket meets the USB 3.0 specification; the output plug of the power converter outputs the electric power by connecting to a first pin and a fourth pin of the customized USB socket, and receives the output signal of the control unit through a seventh pin of the customized USB socket.

4. The USB interface of claim 2, wherein the custom USB socket meets the Mini/Micro USB 2.0 specification; the output plug of the power converter outputs the electric power through connecting to a first pin and a fifth pin of the customized USB socket and receives the output signal of the control unit through a fourth pin of the customized USB socket.

5. A mobile device, comprising:
a main device; and
a universal serial bus (USB) interface coupled to the main device, comprising:
a customized USB socket having an accommodating portion for connecting to a standard USB plug or an output plug of a power converter, wherein the depth of the accommodating portion is greater than the depth of a standard USB socket;
a detection member disposed in the accommodating portion of the customized USB socket, wherein the standard USB plug does not contact the detection member when the standard USB plug is plugged into the customized USB socket, and the output plug of the power converter is in contact with the detection member when the output plug of the power converter is plugged into the customized USB socket; and
a control unit, coupled to the customized USB socket, changing the status of an output signal of the control unit when the output plug of the power converter is in contact with the detection sheet to inform the power converter to output electric power that is greater than that defined by a standard USB specification.

6. The mobile device of claim 5, wherein an input of the control unit is coupled to the detection member; and
wherein the detection member is connected to a ground node when the output plug of the power converter is in contact with the detection member, and whereby the voltage potential of the ground node is transmitted, through the detection member, to the control unit and causes the control unit to change the status of the output signal of the control unit.

7. The mobile device of claim 6, wherein the customized USB socket meets the USB 3.0 specification; the output plug of the power converter outputs the electric power through a first pin and a fourth pin of the customized USB socket, and receives the output signal of the control unit through a seventh pin of the customized USB socket.

8. The mobile device of claim 6, wherein the customized USB socket meets the Mini/Micro USB 2.0 specification; the output plug of the power converter outputs the electric power through a first pin and a fifth pin of the customized USB socket and receives the output signal of the control unit through a fourth pin of the customized USB socket.

9. The mobile device of claim 7, wherein the output plug of the power converter has at least three pins corresponding to the first, fourth and seventh pins of the customized USB socket.

10. The mobile device of claim 8, wherein the output plug of the power converter has at least three pins corresponding to the first, fourth and fifth pins of the customized USB socket.
